(19) United States
(12) Patent Application Publication
(10) Pub. No.: US 2010/0135620 A1
(43) Pub. Date: Jun. 3, 2010

(54) SMALL FORM-FACTOR PLUGGABLE TRANSCEIVER MODULE

(75) Inventor: Huitsuo CHOU, HSINCHU COUNTY (TW)

Correspondence Address: BRIAN M. MCINNIS, 12th Floor, Ruttonjee House, 11 Duddell Street, Hong Kong, HK

(73) Assignee: Ming-Feng HO, HSINCHU COUNTY (TW)

(21) Appl. No.: 12/490,326

(22) Filed: Jun. 24, 2009

(30) Foreign Application Priority Data
Dec. 1, 2008 (TW) 97146637

(51) Int. Cl. G02B 6/36; H04B 10/00

(52) U.S. Cl. 385/88; 398/135

(57) ABSTRACT

A small form-factor pluggable transceiver module including a first optical transceiver device, a second optical transceiver device and a circuit board electrically connected to the first optical transceiver device and the second optical transceiver device. The circuit board includes golden fingers having 20 pins. The width of the circuit board fulfills the width requirement of the small form-factor pluggable transceiver multisource agreement.

### RELATED APPLICATIONS

This application claims priority to Taiwan Application Serial Number 97146637, filed Dec. 1, 2008, which is herein incorporated by reference.

### FIELD OF THE INVENTION

The present invention generally relates to a small form-factor pluggable transceiver module. More particularly, this invention relates to pins of a small form-factor pluggable transceiver module.

### BACKGROUND OF THE INVENTION

As network technology grows rapidly, optoelectronic communication technology is becoming more popular because optoelectronic communication transfers a large amount of data at a high speed. One of the critical components in optoelectronic communication is the optical transceiver module, which includes a receiver to transform a received optical signal into an electronic signal, and a transmitter to transform an electronic signal into an optical signal and to transmit the optical signal.

Networking equipment such as a hub can be equipped with optical transceiver modules as described above. Fiber channel cables can be plugged into networking equipment through the optical transceiver modules. In recent fiber channel products, Gigabit Interface Converter (GBIC) optical transceiver modules have been replaced by Small Form Factor (SFF) optical transceiver modules. In addition, the SFF optical transceiver modules are further improved to Small Form Factor Pluggable (SFP) optical transceiver modules. The SFP optical transceiver module has a more compact volume than that of the GBIC optical transceiver module and can be hot-pluggable. Thus, designers can put more optical transceiver modules in the same area of the networking equipment by using the SFP optical transceiver modules with the hot-pluggable function so that the SFP optical transceiver modules can be easily installed and replaced.

### SUMMARY OF THE INVENTION

One objective of the present invention is to provide a small form-factor pluggable transceiver module having a plurality of optoelectronic converter modules and a plurality of printed circuit boards. At least one of the printed circuit boards has golden fingers whose external dimensions are the same with the golden fingers of a small form-factor pluggable transceiver module with only one communication port complying with the requirement of the small form-factor pluggable transceiver multisource agreement (SFP transceiver MSA).

To achieve these and other advantages and in accordance with the objective of the present invention, as the embodiment broadly describes herein, the present invention provides a small form-factor pluggable transceiver module including a first optical transceiver device, a second optical transceiver device, and a circuit board electrically connecting the first optical transceiver device and the second optical transceiver device. The circuit board includes golden fingers having 20 pins.

The width of the golden fingers of the small form-factor pluggable transceiver module complies with the width requirement of the small form-factor pluggable transceiver multisource agreement (SFP transceiver MSA), for example, about 9.2 mm. The first optical transceiver device includes a first optoelectronic converter module, and the second optical transceiver device includes a second optoelectronic converter module. The first optoelectronic converter module and the second optoelectronic converter module are bi-directional optical sub-assemblies (BOSAs).

The external dimensions of the small form-factor pluggable transceiver module comply with the requirement of the small form-factor pluggable transceiver multisource agreement (SFP transceiver MSA), for example, about 13.5 mm.

The golden fingers are divided into a first high speed signal transmission area, a second high speed signal transmission area, and a first signal separation area disposed between the first high speed signal transmission area and the second high speed signal transmission area. The golden fingers of the first high speed signal transmission area include pins 17-20 functioned as TX−A, TX+A, Tx_DISA and GNDA; the golden fingers of the second high speed signal transmission area include pins 11-14 functioned as GNDB, Tx_DISB, TX+B and TX−B; and the golden fingers of the first signal separation area includes pins 15-16 functioned as VccB and VccA.

Furthermore, the golden fingers are further divided into a third high speed signal transmission area, a fourth high speed signal transmission area, and a second signal separation area disposed between the third high speed signal transmission area and the fourth high speed signal transmission area. The golden fingers of the third high speed signal transmission area include pins 1-3 functioned as RX−A, RX+A and LOSA; the golden fingers of the fourth high speed signal transmission area include pins 8-10 functioned as LOSB, RX+B and RX−B; and the golden fingers of the second signal separation area includes pins 4-7 functioned as MOD2A, MOD1A, MOD1B and MOD2B.

It is worth noting that the golden fingers of the first high speed signal transmission area and the golden fingers of the third high speed signal transmission area are respectively disposed on two distinct surfaces of the printed circuit board. The golden fingers of the first high speed signal transmission area further include pins 17 and 18 functioned as TX−A and TX+A; and the golden fingers of the third high speed signal transmission area further include pins 1 and 2 functioned as RX−A and RX+A. The golden fingers of the second high speed signal transmission area and the golden fingers of the fourth high speed signal transmission area are also disposed on the two distinct surfaces of the printed circuit board. The golden fingers of the second high speed signal transmission area further include pins 13 and 14 functioned as TX+B and TX−B; and the golden fingers of the fourth high speed signal transmission area further include pins 9 and 10 functioned as RX+B and RX−B.

Accordingly, the front portion of the small form-factor pluggable transceiver module according to the present invention can contain two optoelectronic converter modules, such as two BOSAs, in a standard width of a single standard SFP optoelectronic converter module so as to increase the density of the optoelectronic converter modules in the electronic equipments. The small form-factor pluggable transceiver module according to the present invention further modifies the configuration and function of the golden fingers on the printed circuit board without changing the external dimensions of the standard SFP optical transceiver module to contain two sets of golden fingers for two optical transceiver devices and effectively prevent signal interference therebetween.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a preferred embodiment of a small form-factor pluggable transceiver module according to the present invention; and

FIG. 2 illustrates an exemplary pin arrangement of the small form-factor pluggable transceiver module according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

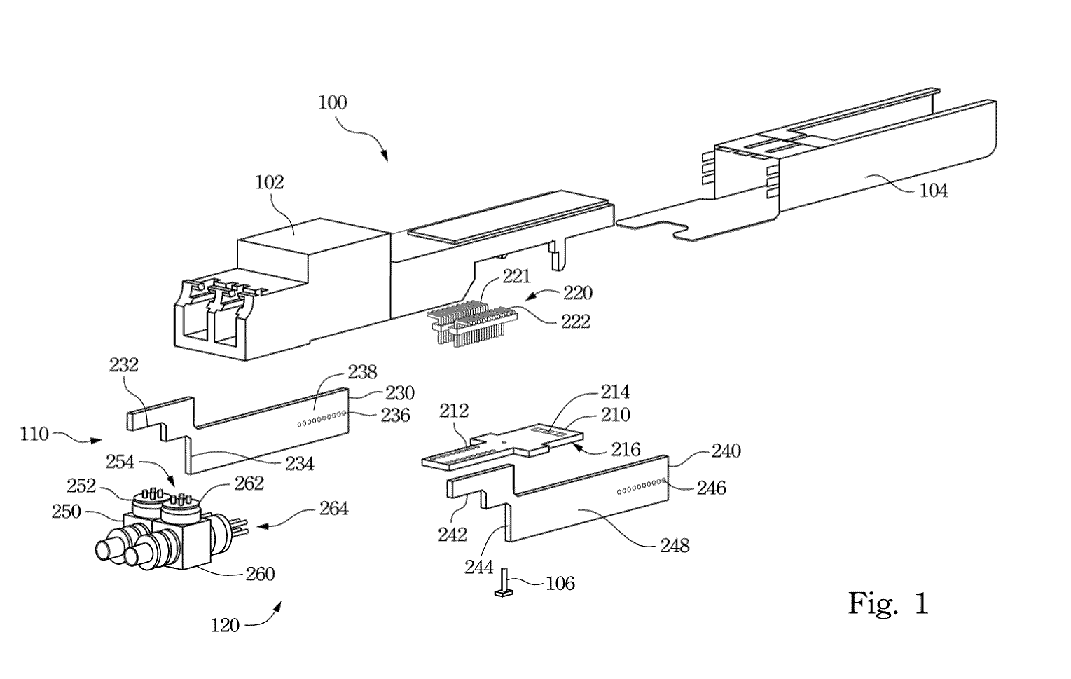

Refer to FIG. 1. FIG. 1 illustrates a preferred embodiment of a small form-factor pluggable transceiver module according to the present invention. The small form-factor pluggable transceiver module 100 includes a module base 102, a protective case 104, a plurality of optical transceiver devices, e.g. a first optical transceiver device 110 and a second optical transceiver device 120, and a third circuit board 210 disposed therein. The first optical transceiver device 110 includes a first circuit board 230, and the second optical transceiver device 120 includes a second circuit board 240. The first circuit board 230 and the second circuit board 240 are parallel to each other, and the third circuit board 210 is disposed between the first circuit board 230 and the second circuit board 240. Preferably, the third circuit board 210 is further perpendicular to the first circuit board 230 and the second circuit board 240.

The third circuit board 210 is equipped with golden fingers 214 and golden fingers 216 at the rear portion thereof to allow the small form-factor pluggable transceiver module 100 hot-plugging with an electronic equipment, e.g. a networking equipment.

The external dimensions of the golden fingers 214 and the golden fingers 216 disposed at the rear portion the third circuit board 210 fully comply with the dimension requirement of the small form-factor pluggable transceiver multisource agreement (SFP transceiver MSA), and the external dimensions of the golden fingers 214 and the golden fingers 216 are the same with a standard SFP-MSA transceiver module having only one communication port. That is to say, the external dimension of the third circuit board 210 is about 9.2 mm and fully complies with the requirement of the SFP-MSA. Therefore, the standard SFP-MSA connector can conveniently connect with the golden fingers of the small form-factor pluggable transceiver module.

The third circuit board 210 is electrically connected to the first circuit board 230 with L-shaped terminals 220. The first circuit board 230 includes through holes 236, and the third circuit board 210 includes through holes 212. The first terminals 221 of the L-shaped terminals 220 respectively pass through the through holes 236 of the first circuit board 230 and the through holes 212 of the third circuit board 210 to electrically connect the first circuit board 230 and the third circuit board 210. Because the additional third circuit board 210 is disposed between the first circuit board 230 and the second circuit board 240, the small form-factor pluggable transceiver module according to the present invention has an extended circuit board area to allow increasing the circuit variation for the small form-factor pluggable transceiver module. In addition, the small form-factor pluggable transceiver module can easily hot-plug with the electronic equipment with the golden fingers 214 and the golden fingers 216 on the third circuit board 210.

Moreover, the front portion of the first circuit board 230 is formed an L-shaped form with a first portion 234 and a second portion 232 to respectively couple to a transmitting end 254 and a receiving end 252 of the first optoelectronic converter module 250 to transmit and receive the optical signals. The rear portion of the first circuit board 230 is a base portion 238 and the through holes 236 are formed thereon to couple to the L-shaped terminals 220. The positions of the transmitting end 254 and the receiving end 252 of the first optoelectronic converter module 250 can be switched without departing from the spirit and scope of the present invention. In addition, the width of the third circuit board 210 near the through holes 212 is preferably smaller than the width of the third circuit board 210 near the golden fingers 216 to allow the width of the third circuit board 210 near the golden fingers 216 to comply with the, requirement of the small form-factor pluggable transceiver multisource agreement (SFP transceiver MSA). In addition, the external dimensions of the small form-factor pluggable transceiver module 100 comply with the requirement of the SFP transceiver MSA. In addition, at the front portion of the small form-factor pluggable transceiver module 100, two optoelectronic converter modules can be contained. Therefore, the first optoelectronic converter module 250 and the second optoelectronic converter module 260 can be respectively configured in the first optical transceiver device 110 and the second optical transceiver device 120 to allow the two optical transceiver devices disposing in a width limitation for a single standard SFP optical transceiver device so as to increase the density of the optical transceiver devices in the electronic equipment.

The first optoelectronic converter module 250 can be a bi-directional optical sub-assembly (BOSA) and the second optoelectronic converter module 260 can also be a bi-directional optical sub-assembly (BOSA). Therefore, the first optoelectronic converter module 250 and the second optoelectronic converter module 260 can both receive and transmit the optical signals. Accordingly, the small form-factor pluggable transceiver module 100 according to the present invention can contain two independent BOSA to still comply with a standard width requirement of the SFP-MSA. Therefore, the total width of the first optical transceiver device 110 with the hot-pluggable function and the second optical transceiver device 120 with the hot-pluggable function is about 13.5 mm.

The small form-factor pluggable transceiver module according to the present invention has at least two communication ports. However, the external dimensions of the golden fingers for a standard SFP-MSA communication port are not enough to contain two standard SFP-MSA communication ports. Moreover, the high speed signals are easily interfered with each other in such a small room containing two or more communication ports.

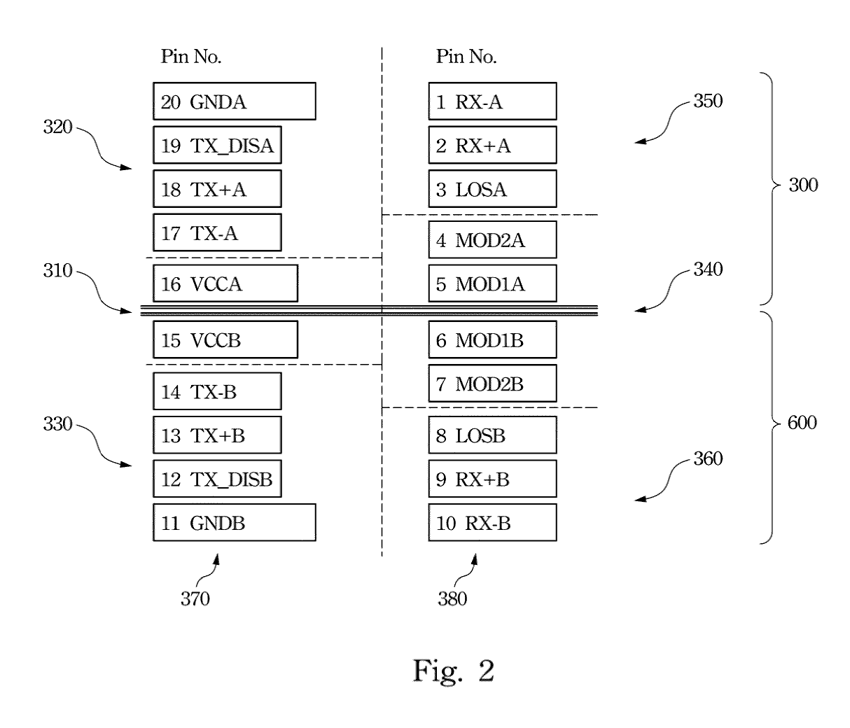

Refer to FIG. 2. FIG. 2 illustrates an exemplary pin arrangement of the small form-factor pluggable transceiver module according to the present invention. The golden fingers 214 and the golden fingers 216 are disposed on two surfaces of the third circuit board 210 at the rear portion of the third circuit board 210 to plug to a standard connector complying with the requirement of the SFP-MSA.

The printed circuit board has communication pins 370 on the first surface and communication pins 380 on the second surface. To connect with a standard connector complying with the requirement of SFP-MSA, the quantity of the communication pins 370 and the quantity of the communication pins 380 are both ten and parallel to each other. The communication pins 370 are defined as pin 1 to pin 10, and the communication pins 380 are defined as pin 11 to pin 20. In addition, a first set of communication pins 300 (Port A as mentioned in Table 1) is composed of pin 1 to pin 5 and pin 16 to pin 20, and a second set of communication pins 600 (Port B as mentioned in Table 1) is composed of pin 6 to pin 10 and pin 11 to pin 15.

Furthermore, to improve the stability of the small form-factor pluggable transceiver module according to the present invention, the golden fingers can be divided into a first high speed signal transmission area 320, a second high speed signal transmission area 330, a third high speed signal transmission area 350, a fourth high speed signal transmission area 360, a first signal separation area 310 and a second signal separation area 340. The first signal separation area 310 and the second signal separation area 340 can effectively separate the first high speed signal transmission area 320, the second high speed signal transmission area 330, the third high speed signal transmission area 350, and the fourth high speed signal transmission area 360.

TABLE 1
definitions and functions of golden fingers

| Pin No. | Pin Name | Function |
|---|---|---|
| 1 | RX−A | Port A Inv. Receiver Data out |
| 2 | RX+A | Port A Receiver Data Out |
| 3 | LOSA | Port A Loss of Signal |
| 4 | MOD2A | Port A Module Definition 2 |
| 5 | MOD1A | Port A Module Definition 1 |
| 6 | MOD1B | Port B module Definition 1 |
| 7 | MOD2B | Port B module Definition 2 |
| 8 | LOSB | Port B Loss of Signal |
| 9 | RX+B | Port B Receiver Data Out |
| 10 | RX−B | Port B Inv. Receiver Data Out |
| 11 | GNDB | Port B Ground |
| 12 | Tx DISB | Port B Tx Disable |
| 13 | TX+B | Port B Transmitter Data In |
| 14 | TX−B | Port B Inv. Transmitter Data In |
| 15 | VccB | Port B VCC |
| 16 | VccA | Port A VCC |
| 17 | TX−A | Port A Inv. Transmitter Data In |
| 18 | TX+A | Port A Transmitter Data In |
| 19 | Tx DISA | Port A Disable |
| 20 | GNDA | Port A Ground |

Simultaneously refer to Table 1 and FIG. 2. The first high speed signal transmission area 320 includes pin 17 to pin 20, the second high speed signal transmission area 330 includes pin 11 to pin 14, and pins 15 (Vcc B) and pins 16 (Vcc A) of the first signal separation area 310 are disposed between the first high speed signal transmission area 320 and the second high speed signal transmission area 330 to prevent from the high speed signal interference therebetween. With the same reason, the third high speed signal transmission area 350 includes pin 1 to pin 3, and the fourth high speed signal transmission area 360 includes pin 8 to pin 10. A low speed signal pin 4 (MOD 2A), a low speed signal pin 5 (MOD 1A), a low speed signal pin 6 (MOD 1B) and a low speed signal pin 7 (MOD 2B) of the second signal separation area 340 are disposed between the third high speed signal transmission area 350 and the fourth high speed signal transmission area 360 to prevent from the high speed signal interference therebetween.

Furthermore, the first high speed signal transmission area 320 and the third high speed signal transmission area 350 are disposed on two surfaces of the printed circuit board to prevent from signal interference therebetween. The second high speed signal transmission area 330 and the fourth high speed signal transmission area 360 are disposed on two surfaces of the printed circuit board to prevent from signal interference therebetween. It is worth noting that pin 1 (RX−A) and pin 2 (RX+A) are disposed on one surface that differs from the surface that pin 17 (TX−A) and pin 18 (TX+A) are disposed thereon. In addition, observing the pins from a direction perpendicular to the surfaces of the printed circuit board, the pin 1 (RX−A) and the pin 2 (RX+A) are not overlapped with the pin 17 (TX−A) and the pin 18 (TX+A) to further prevent from the signal interference therebetween.

With the same reason, pin 9 (RX+B) and pin 10 (RX−B) are also disposed on one surface that differs from the surface that pin 13 (TX+B) and pin 14 (TX−B) are disposed thereon. In addition, observing the pins from the direction perpendicular to the surfaces of the printed circuit board, the 9 (RX+B) and the pin 10 (RX−B) are not overlapped with the pin 13 (TX+B) and pin 14 (TX−B) to further prevent from the signal interference therebetween. The pins of RX−A, RX+A, RX−B, RX+B, TX−A, TX+A, TX−B and TX+B can disposed on different positions of the printed circuit board without departing from the spirit and scope of the present invention. Preferably, while observing the pins from the direction perpendicular to the surfaces of the printed circuit board, these pins RX−A, RX+A, RX−B, RX+B, TX−A, TX+A, TX−B and TX+B are not overlapping each other.

Accordingly, the front portion of the small form-factor pluggable transceiver module according to the present invention can contain two optoelectronic converter modules, such as two BOSAs, in a standard width of a single standard SFP optoelectronic converter module to increase the density of the optoelectronic converter modules in the electronic equipments. The small form-factor pluggable transceiver module according to the present invention further utilizes the golden fingers of the third circuit board disposed between the first circuit board and the second circuit board to increase the circuit board area without changing the external dimensions of a single standard SFP optical transceiver module so as to increase the variational capability for the circuit on the circuit board and provide the hot-pluggable function for the small form-factor pluggable transceiver module.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A small form-factor pluggable transceiver module, comprising:
a first optical transceiver device;
a second optical transceiver device; and
a circuit board electrically connecting the first optical transceiver device and the second optical transceiver device, wherein the printed circuit board comprises golden fingers having 20 pins.

2. The small form-factor pluggable transceiver module of claim 1, wherein a width of the golden fingers complies with a width requirement of a small form-factor pluggable transceiver multisource agreement (SFP transceiver MSA).

3. The small form-factor pluggable transceiver module of claim 1, wherein a width of the printed circuit board is about 9.2 mm.

4. The small form-factor pluggable transceiver module of claim 1, wherein the first optical transceiver device comprises a first optoelectronic converter module, and the second optical transceiver device comprises a second optoelectronic converter module.

5. The small form-factor pluggable transceiver module of claim 4, wherein the first optoelectronic converter module and the second optoelectronic converter module are bi-directional optical sub-assemblies (BOSAs).

6. The small form-factor pluggable transceiver module of claim 1, wherein external dimensions of the small form-factor pluggable transceiver module comply with a requirement of a small form-factor pluggable transceiver multisource agreement (SFP transceiver MSA).

7. The small form-factor pluggable transceiver module of claim 1, wherein a width of the small form-factor pluggable transceiver module is about 13.5 mm.

8. The small form-factor pluggable transceiver module of claim 1, wherein the golden fingers are divided into a first high speed signal transmission area, a second high speed signal transmission area, and a first signal separation area disposed between the first high speed signal transmission area and the second high speed signal transmission area.

9. The small form-factor pluggable transceiver module of claim 8, wherein the golden fingers of the first high speed signal transmission area comprise pins 17-20 functioned as TX−A, TX+A, Tx_DISA and GNDA; the golden fingers of the second high speed signal transmission area comprise pins 11-14 functioned as GNDB, Tx_DISB, TX+B and TX−B; and the golden fingers of the first signal separation area comprises pins 15-16 functioned as VccB and VccA.

10. The small form-factor pluggable transceiver module of claim 8, wherein the golden fingers are further divided into a third high speed signal transmission area, a fourth high speed signal transmission area, and a second signal separation area disposed between the third high speed signal transmission area and the fourth high speed signal transmission area.

11. The small form-factor pluggable transceiver module of claim 10, wherein the golden fingers of the third high speed signal transmission area comprise pins 1-3 functioned as RX−A, RX+A and LOSA; the golden fingers of the fourth high speed signal transmission area comprise pins 8-10 functioned as LOSB, RX+B and RX−B; and the golden fingers of the second signal separation area comprises pins 4-7 functioned as MOD2A, MOD1A, MOD1B and MOD2B.

12. The small form-factor pluggable transceiver module of claim 10, wherein the golden fingers of the first high speed signal transmission area and the golden fingers of the third high speed signal transmission area are respectively disposed on two distinct surfaces of the printed circuit board.

13. The small form-factor pluggable transceiver module of claim 12, wherein the golden fingers of the first high speed signal transmission area further comprise pins 17 and 18 functioned as TX−A and TX+A; and the golden fingers of the third high speed signal transmission area further comprise pins 1 and 2 functioned as RX−A and RX+A.

14. The small form-factor pluggable transceiver module of claim 12, wherein the golden fingers of the second high speed signal transmission area and the golden fingers of the fourth high speed signal transmission area are respectively disposed on the two distinct surfaces of the printed circuit board.

15. The small form-factor pluggable transceiver module of claim 14, wherein the golden fingers of the second high speed signal transmission area further comprise pins 13 and 14 functioned as TX+B and TX−B; and the golden fingers of the fourth high speed signal transmission area further comprise pins 9 and 10 functioned as RX+B and RX−B.
